(19) United States
(12) Patent Application Publication
(10) Pub. No.: US 2019/0100204 A1
(43) Pub. Date: Apr. 4, 2019

(54) METHOD OF ASSISTING IN THE CONTROL OF A PRIME MOVER OF A VEHICLE, APPARATUS FOR ASSISTING IN THE CONTROL OF A PRIME MOVER OF A VEHICLE, AND A VEHICLE COMPRISING SUCH AN APPARATUS

(71) Applicant: JAGUAR LAND ROVER LIMITED, Warwickshire (GB)

(72) Inventors: Alex PLIANOS, Whitley (GB); Kestutis JANKEVICIUS, Whitley (GB)

(21) Appl. No.: 16/145,560

(22) Filed: Sep. 28, 2018

(30) Foreign Application Priority Data
Oct. 2, 2017 (GB) 1716038.3

(51) Int. Cl. B60W 30/188

(52) U.S. Cl. CPC B60W 30/188; B60W 2520/10; B60W 2710/06; B60W 2710/18; B60W 2710/021

(57) ABSTRACT

Method and apparatus for assisting in the control of a prime mover of a vehicle. A target speed that must be reached by the vehicle at a target position on a current path of the vehicle is determined. At least one coasting profile is estimated for at least part of the vehicle path before the target position. The coasting profile(s) are estimated at least partly based on a geometry (such as elevation) of the vehicle path. Coasting profile(s) that meet at least one predetermined coasting requirement is determined. A coasting signal is output based on the determined coasting profile. Based on the coasting signal, the prime mover may be controlled to place the vehicle into a coasting mode based on the at least one determined coasting profile. Alternatively, based on the coasting signal, feedback is provided to a vehicle user to place the vehicle into a coasting mode, such that the vehicle if placed in the coasting mode by the user will coast in accordance with the at least one identified coasting profile.

### CROSS REFERENCE TO RELATED APPLICATION

This application claims priority to United Kingdom Patent Application No. GB 1716038.3, filed on 2 Oct. 2017.

### TECHNICAL FIELD

The present disclosure relates to controlling a prime mover of a vehicle.

Aspects of the invention relate to a method of controlling a prime mover of a vehicle, apparatus for controlling a prime mover of a vehicle, and a vehicle comprising such an apparatus.

### BACKGROUND

Various driver assistance aids are used in modern vehicles. For example, speed control systems such as cruise control may be used to maintain a constant speed within a narrow speed range. More advanced versions of cruise control and other driver assistance technologies may control the vehicle's speed in a more complex manner, such as slowing down for corners, roundabouts, speed limit changes and junctions.

Typically, such technologies use a combination of braking and prime mover control in order to gradually reduce a speed of the vehicle from a current speed to a target speed at some point ahead on the predicted path. The prime mover is arranged to provide force with which to propel the vehicle and may comprise an internal combustion engine, an electric motor or a combination of the two. When controlling the speed, the technology must take into account various deceleration profiles. For example, a maximal deceleration profile may represent the maximum possible braking capacity for the vehicle, and is typically only used in emergency situations due to its effect on passenger comfort. A less aggressive profile is a maximum regeneration profile, which may be used in hybrid or electric vehicles. This profile represents a maximum regeneration that can be gained from an electric machine (e.g., a motor/generator) of the car.

In addition to these profiles, user comfort may need to be taken into account. For example, a maximum regeneration profile may be used based on vehicle user comfort, known as a comfort profile. In that case, a lower, that is to say, a more gentle deceleration profile may take precedence, to ensure user comfort in use.

Speed control is also an important aspect of autonomous and semi-autonomous vehicle control systems.

There is pressure on vehicle manufacturers to reduce fuel/energy consumption to improve vehicle efficiency. There are many ways in which fuel/energy consumption may be reduced, ranging from reducing vehicle weight to educating users. Cruise control systems do not, in general, seek to improve fuel/energy consumption.

It is an aim of the present invention to address disadvantages of the prior art.

### SUMMARY OF THE INVENTION

Aspects and embodiments of the invention provide a method of controlling a prime mover of a vehicle, apparatus for controlling a prime mover of a vehicle, and a vehicle comprising such an apparatus as claimed in the appended claims.

According to an aspect of the invention, there is provided a method of assisting in the control of a prime mover of a vehicle, the method comprising:

determining a target speed that must be reached by the vehicle at a target position on a current path of the vehicle;

estimating at least one coasting profile for at least part of the vehicle path before the target position, wherein the at least one coasting profile is estimated at least partly based on a geometry of the at least part of the vehicle path;

determining at least one of the coasting profiles that meets at least one predetermined coasting requirement; and

outputting a control signal to either:
control the prime mover to place the vehicle into a coasting mode based on the at least one determined coasting profile; or
provide feedback to a vehicle user to place the vehicle into a coasting mode, such that the vehicle if placed in the coasting mode by the user will coast in accordance with the at least one identified coasting profile.

The vehicle may have a predetermined maximum deceleration rate, and each of the at least one estimated coasting profiles may include at least one period of deceleration that is lower than the maximum deceleration rate.

The at least one or more predetermined coasting requirements may comprise one or more of:

a minimum coasting mode duration;

a minimum coasting mode distance;

a minimum coasting mode speed; and

a maximum coasting mode speed.

Controlling the prime mover may comprise one or more of:

placing a transmission associated with the prime mover into neutral;

disengaging a clutch associated with the prime mover;

turning off the prime mover; and

modulating one or more engine system actuators, such as an exhaust gas recirculation valve, variable geometry turbocharger, intake throttle, and continuous variable valve timing, so as to reduce or minimise pumping losses.

The vehicle may include a regenerative power source, and the coasting mode may include regenerative braking.

The predetermined maximum deceleration rate may be based on comfort-based deceleration profile.

The vehicle may include an electric machine, and the coasting mode may include providing drive via the electric machine in order to increase a total coasting distance and/or time.

The vehicle may include one or more braking mechanisms, and the coasting mode may include providing braking via at least one of the braking mechanisms in order to increase a total coasting distance and/or time.

Identifying the at least one coasting profile may comprise selecting a coasting profile that maximises a coasting mode distance and/or coasting mode time.

The vehicle may have at least a first speed range that is used in the estimating of the at least one coasting profile, and a second speed range for when the vehicle is not in the coasting mode, wherein the first speed range is wider than the second speed range.

According to another aspect of the invention, there is provided a vehicle coasting system for assisting in the control of a prime mover of a vehicle, the vehicle coasting system comprising:

means for determining a target speed that must be reached by the vehicle at a target position on a current path of the vehicle; means for estimating at least one coasting profile for at least part of the vehicle path before the target position, wherein the at least one coasting profile is estimated at least partly based on a geometry of the at least part of the vehicle path;

means for determining at least one of the coasting profiles that meets at least one predetermined coasting requirement; and means for outputting a coasting signal for either: controlling the prime mover to place the vehicle into a coasting mode based on the at least one determined coasting profile; or providing feedback to a vehicle user to place the vehicle into a coasting mode, such that the vehicle if placed in the coasting mode by the user will coast in accordance with the at least one identified coasting profile.

The means for estimating at least one coasting profile, may comprise:

an electronic processor having an electrical input for receiving signals indicative of, a value of vehicle speed, a current location of the vehicle, map information, and geometry data relating to the map information; and

an electronic memory device electrically coupled to the electronic processor and having instructions stored therein, wherein

the electronic processor is configured to access the electronic memory device and execute the instructions stored therein such that it is operable to predict the vehicle path based at least in part on the signals indicative of current location of the vehicle and vehicle speed, and, in dependence on the predicted vehicle path and the geometry of that path, estimate the coasting profile.

The means to estimate at least one of the coasting profiles and the means to output a coasting signal may comprise the electronic processor identifying one of said generated coasting profiles and generating said coasting signal in response thereto.

The vehicle may have a predetermined maximum deceleration rate, and each of the at least one estimated coasting profiles may include at least one period of deceleration that is lower than the maximum deceleration rate.

The vehicle coasting system may include means for controlling the prime mover to place the vehicle into a coasting mode based on the at least one determined coasting profile.

The vehicle coasting system may include means for providing feedback to a vehicle user to place the vehicle into a coasting mode, such that the vehicle if placed in the coasting mode by the user will coast in accordance with the at least one identified coasting profile.

The at least one or more predetermined coasting requirements comprises one or more of:

a minimum coasting mode duration;

a minimum coasting mode distance;

a minimum coasting mode speed; and

a maximum coasting mode speed.

Controlling the prime mover may comprise one or more of:

placing a transmission associated with the prime mover into neutral;

disengaging a clutch associated with the prime mover;

turning off the prime mover; and

modulating one or more engine system actuators, such as an exhaust gas recirculation valve, variable geometry turbocharger, intake throttle, and continuous variable valve timing, so as to reduce or minimise pumping losses.

The vehicle may include a regenerative power source, and the coasting mode may include regenerative braking.

The predetermined maximum deceleration rate may be based on a comfort-based deceleration profile.

The vehicle may include an electric machine, and the coasting mode may include providing drive via the electric machine in order to increase a total coasting distance and/or time.

The vehicle may include one or more braking mechanisms, and the coasting mode may include providing braking via at least one of the braking mechanisms in order to increase a total coasting distance and/or time.

Identifying the at least one coasting profile may comprise selecting a coasting profile that maximises a coasting mode distance and/or coasting mode time.

The vehicle may have at least a first speed range that is used in the estimating of the at least one coasting profile, and a second speed range for when the vehicle is not in the coasting mode, wherein the first speed range is wider than the second speed range.

The controller may be a coasting control module comprising an electronic processor.

According to another aspect of the invention, there is provided a non-transitory computer readable carrier medium carrying computer readable code for controlling a vehicle to carry out an aspect of the invention.

According to another aspect of the invention, there is provided a non-transitory computer readable carrier medium carrying computer readable code which when executed causes a vehicle to carry out an aspect of the invention.

According to another aspect of the invention, there is provided a computer program product executable on a processor so as to implement an aspect of the invention.

According to another aspect of the invention, there is provided a processor arranged to implement an aspect of the invention.

According to another aspect of the invention, there is provided a vehicle implementing any aspect of the invention.

According to another aspect of the invention, there is provided a method of controlling a prime mover of a vehicle, the method comprising:

determining a target speed that must be reached by the vehicle at a target position on a current path of the vehicle;

estimating at least one coasting profile for at least part of the vehicle path before the target position, each of the at least one estimated coasting profiles including at least one period of deceleration that is lower than the maximum deceleration rate, wherein the at least one coasting profile is estimated at least partly based on a geometry of the at least part of the vehicle path;

determining at least one of the coasting profiles that meets at least one predetermined coasting requirement; and

outputting a control signal to control the prime mover to place the vehicle into a coasting mode based on the at least one determined coasting profile.

According to another aspect of the invention, there is provided a vehicle coasting system for controlling a prime mover of a vehicle, the vehicle coasting system comprising:

means for determining a target speed that must be reached by the vehicle at a target position on a current path of the vehicle;

means for estimating at least one coasting profile for at least part of the vehicle path before the target position, each of the at least one estimated coasting profiles including at least one period of deceleration that is lower than a maximum deceleration rate, wherein the at least one coasting profile is estimated at least partly based on a geometry of the at least part of the vehicle path;

means for determining at least one of the coasting profiles that meets at least one predetermined coasting requirement; and

means to output a coasting signal for controlling the prime mover to place the vehicle into a coasting mode based on the at least one determined coasting profile.

The vehicle coasting system may include means for controlling the prime mover to place the vehicle into a coasting mode based on the at least one determined coasting profile.

The means for determining a target speed, may comprise:

an electronic processor having an electrical input for receiving signals indicative of, a value of the current vehicle speed, a current location of the vehicle, map information, and geometry data relating to the map information; and

an electronic memory device electrically coupled to the electronic processor and having instructions stored therein, wherein

the electronic processor is configured to access the electronic memory device and execute the instructions stored therein such that it is operable to determine a target speed that must be reached by the vehicle at a target position on the current path based at least in part on the upcoming changes in geometry of the vehicle path.

The means to estimate at least one of the coasting profiles and the means to output a coasting signal may comprise the electronic processor identifying one of said generated coasting profiles and generating said coasting signal in response thereto.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in the form of a car comprising apparatus for controlling a prime mover of the vehicle according to an embodiment of the invention;

FIG. 2 is a flowchart showing a method of controlling a prime mover of the vehicle according to an embodiment of the invention;

FIG. 3 is a graph of speed versus distance for a vehicle, according to an embodiment of the invention;

FIG. 4 is a graph of speed versus distance for a vehicle, according to an embodiment of the invention;

FIG. 5 is a graph of speed versus distance for a vehicle, according to an embodiment of the invention;

FIG. 6 is a graph of speed versus distance for a vehicle, according to an embodiment of the invention;

FIG. 7 is a graph of speed versus distance for a vehicle, according to an embodiment of the invention;

FIG. 8 is a graph of speed versus distance for a vehicle, according to an embodiment of the invention;

FIGS. 9A to 9D show examples of elevation profiles of a current vehicle path;

FIG. 10 is a graph of speed versus distance for a vehicle, according to an embodiment of the invention;

FIG. 11 is a graph of speed versus distance for a vehicle, according to an embodiment of the invention, along with a terrain map;

FIG. 12 is a graph of speed versus distance for a vehicle, according to an embodiment of the invention, along with longitudinal slope; and

FIG. 13 is a schematic view of an architecture for implementing a method of controlling a vehicle's speed according to an embodiment of the invention.

### DETAILED DESCRIPTION

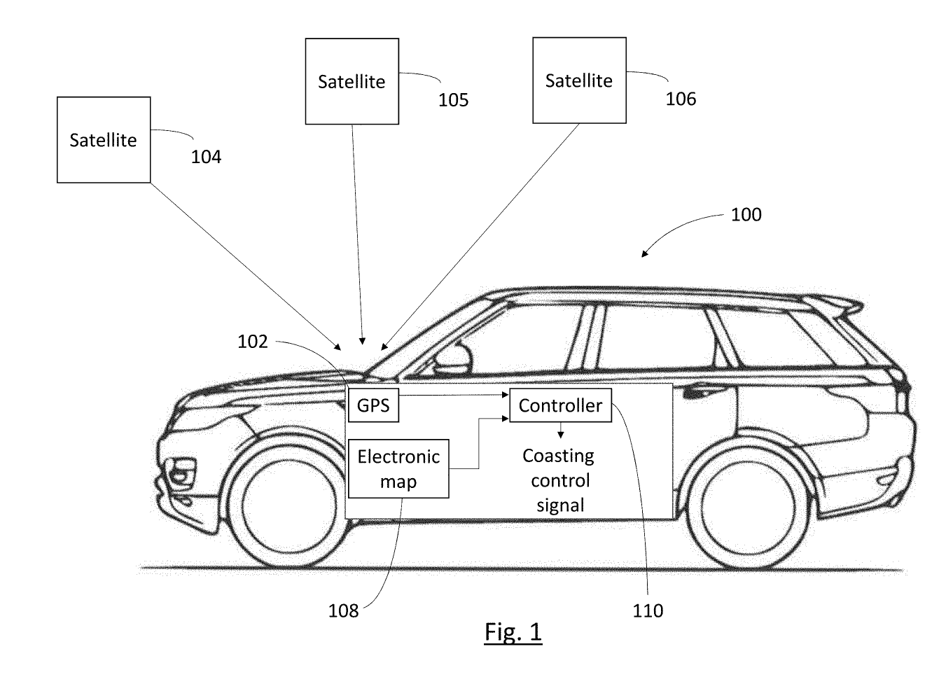

Referring to FIG. 1, a vehicle in the form of vehicle 100 is equipped with technology that enables it to anticipate upcoming changes in geometry of the current path, and in particular, changes in elevation along its current path. A GPS unit 102 receives signals from GPS satellites 104, 105 and 106 in a known manner, and uses the relative time delays of the received signals to triangulate a location of the vehicle 100. The vehicle 100 also has an electronic map unit 108 that stores map information. The map information may include, for example, road topography, locations such as cities, towns and suburbs, and points of interest. Geometric data may also be stored by the electronic map unit. The geometric data includes terrain data, and in particular information about changes in elevation at least in relation to the road topography. The geometric data may optionally include one or more of road curvature, speed limits, roundabouts, heading changes, and any other road attributes that may either contribute to, or require the need for, vehicle speed changes while coasting. The terrain data may be stored locally or accessed remotely via a wireless network (not shown), and may be sourced from the GPS unit 102 or may form part of the map information.

Optionally, the vehicle may use vehicle to vehicle (“V2V”) and vehicle to infrastructure (“V2I) communications to update the map information and/or the geometric data. Additional information, such as variable speed limits, may also be obtained via V2V and/or V2I communications.

A controller 110 accepts information regarding the current location of the vehicle 100 from the GPS unit 102 and information from the electronic map unit 108. The controller 110 may use this information to estimate or determine a path that the vehicle is intended to follow. The path may be based on several possibilities. For example, the user may input a destination and all route information into a satellite navigation (“satnav”) interface. From this, the vehicle can determine with reasonable certainty the likely path that the vehicle will follow. Where a route is determined in advance, such as when satnav is in use, it may be followed by the vehicle automatically (e.g., in a fully autonomous car), semi-automatically (e.g., using a driver assist function) or by way of voice navigation commands to a human user.

If the user is not using the satnav function, a probable path may be calculated based on electronic map information. For example, a driver or user on a highway or motorway is likely to remain on that road, possibly for some distance, and therefore the path is relatively easy to predict.

The electronic map information may optionally be combined with information from vehicle sensors that describe vehicle state. For example, a user such as a driver using an indicator or turn-signal while slowing down at a particular point on the road suggests that the vehicle is about to turn in the direction indicated by the indicator selection.

In other embodiments, V2V and/or V2I communications may be used to estimate or determine the likely vehicle path. For example, if a V2I communication is received indicating that the road ahead is closed, the vehicle can determine the likely path the user will take to avoid the closed road.

In yet other embodiments, previous user behaviour may be used as an input to path estimation. For example, if the user regularly commutes to and from work around certain times, the vehicle may assume that the destination is home or work when the user is using the vehicle during those periods, and that the most likely path is that which the user takes every day.

Although illustrated as being within the vehicle 100, it will be appreciated that the controller 110 and/or map unit 108 may be remotely located on one or more servers or other computer(s) accessible by the vehicle 100. The GPS unit 102 will usually be local to the vehicle 100, but in other embodiments the information regarding the current location of the vehicle 100 may be provided in other ways. For example, other forms of location determination may be used, such as different satellite positioning systems (e.g., the European Galileo positioning system), time delay triangulation using telecommunication base stations signals, inertial-based measurement systems, or any combination thereof.

Also, although illustrated as stand-alone components, any or all of the GPS unit 102, electronic map unit 108 and controller 110 may be implemented wholly or partly in software run on one or more processors, and/or wholly or partly as part of hardware that is responsible for other processing tasks in the car. For example, a general purpose processing unit (not shown) may implement the functions of any or all of the GPS unit 102, electronic map unit 108 and controller 110, in conjunction with any required additional hardware (e.g., antennas and RF circuitry for GPS signal reception and processing).

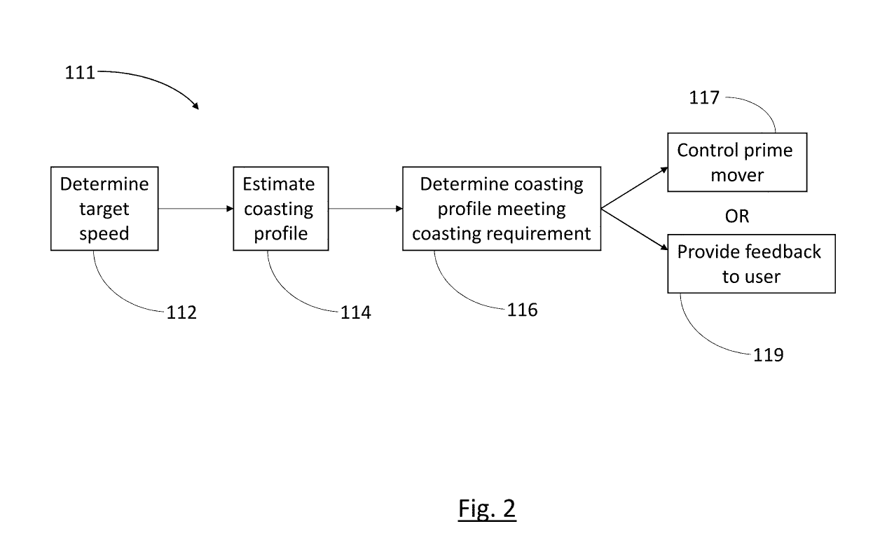

By using terrain data, a method 111 of controlling a prime mover of the vehicle may be implemented. Referring to FIG. 2, a target speed is determined 112. The target speed is a speed that must be reached by the vehicle at a target position on a current path of the car. The target speed and/or the target position may be a function of a change in conditions on the current path. For example, there may be a corner ahead that cannot be traversed at the car's current speed, so a target speed is determined to which the vehicle must slow by a certain point on the path before the corner. Alternatively, there may be a change in the posted or legal speed limit requiring the vehicle to slow down, so a target speed is determined to which to vehicle must slow by the point on the path at which the posted or legal speed limit changes.

At least one coasting profile is estimated 114 for at least part of the vehicle path before the target position. The or each coasting profile is estimated at least partly based on a geometry of the at least part of the vehicle path. The vehicle path is the current most likely path that the vehicle will take based on, for example, a satnav route that is presently being followed autonomously, semi-autonomously, or manually by the driver of the vehicle. In each case, the throttle will at least partly be controlled by the vehicle 100 in view of the cruise control or driver assistance function being engaged. As will be described in more detail below, the or each coasting profile represents a predicted vehicle speed over a time and/or distance, and is generated based on a geometry of at least a portion of the predicted vehicle path. Each of the at least one estimated coasting profiles includes at least one period of deceleration that is lower than the maximum deceleration profile.

At least one of the coasting profiles that meets at least one predetermined coasting requirement is determined 116. As described in more detail below, this determination may be made based on one or more factors, such as maximising fuel efficiency over some portion of the path, or maintaining a vehicle speed at, above, or below a particular speed or deceleration profile.

As described in more detail below, the prime mover may then be controlled 117 to place the vehicle into a coasting mode based on the at least one determined coasting profile. Alternatively, feedback may be provided 119 to a vehicle user to place the vehicle into a coasting mode, such that the vehicle if placed in the coasting mode by the user will coast in accordance with the at least one identified coasting profile.

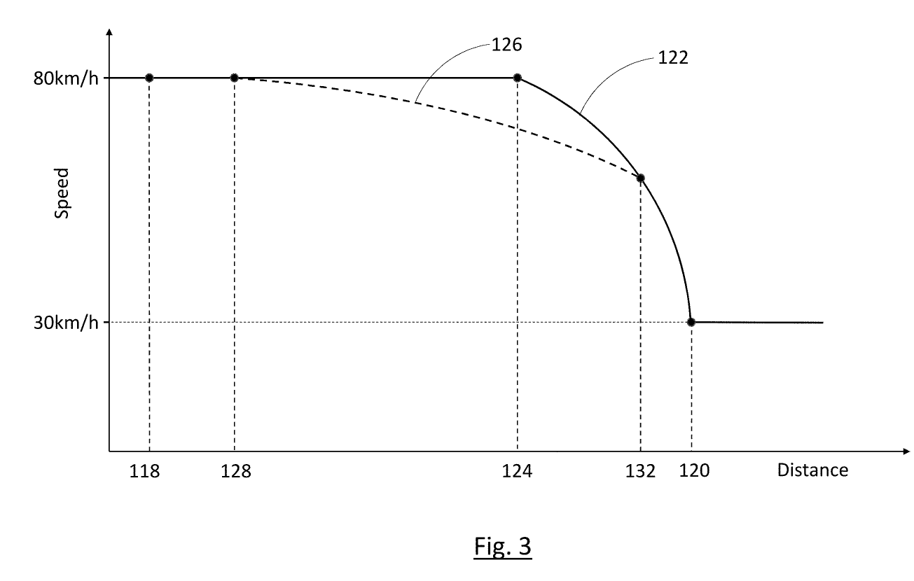

Turning to FIG. 3, there is shown a graph of speed versus distance for the vehicle 100 employing an embodiment of the present invention. The vehicle 100 is initially moving at 80 km/h at point 118. The vehicle 100 determines (or detects) of a change in speed limit to 30 km/h at point 120 in the distance. The vehicle 100 may become aware of this need for a change in speed as a result of looking ahead by a continuous distance (1.5 km, for example), or may pre-analyse some or all of the predicted path in advance. The speed limit for a given location may be determined from data held in an electronic memory associated with the map data, or may additionally or alternatively be provided to the vehicle from a cloud based server. Additionally or alternatively, the speed limit may be detected using forward looking cameras or other suitable means, mounted in the vehicle and arranged to observe and recognise posted speed limit signs positioned adjacent to- and associated with- the road or path on which the vehicle is travelling.

FIG. 3 illustrates a first deceleration profile 122 starting at point 124 that would be used in accordance with a speed control. The deceleration profile extends from point 124 on the path to the point 120 where the speed limit changes to 30 km/h. Where the vehicle 100 includes a motive source having a regenerative braking system such as an electric machine and an energy storage system or a mechanical kinetic energy storage system, this deceleration profile 122 may be, for example, a maximum regeneration efficiency profile, as described above. Where the vehicle 100 does not have a regenerative braking system, the second deceleration profile may be an engine braking profile in which trailing throttle of the internal combustion is used to slow the vehicle at a greater rate than if the clutch were depressed or the transmission ere in neutral. The profile 122 may also include a contribution from friction braking, or a combination of any of the above.

In the embodiment of FIG. 3, a first coasting profile 126 is estimated at least partly based on a geometry of at least part of the vehicle path. The first coasting profile 126 starts at point 128 on the vehicle path. As above, the vehicle path is the current most likely path that the vehicle will take based on, for example, a satnav route that is being followed autonomously, semi-autonomously, or manually by the driver of the vehicle. The geometry of the path may include the terrain data as described above. From the changes in elevation indicated by the terrain data, it may be estimated how much the vehicle 100 will slow down or speed up as it traverses various sections of the vehicle path during a coasting event.

In the embodiment shown in FIG. 3, the path is relatively flat between point 118 and the point 120 by which it must reach 30 km/h. The coasting profile 126 therefore shows a continuously decreasing speed, starting from point 128 on the path.

In the embodiment of FIG. 3, the first coasting profile 126 intersects the first deceleration profile 122 at point 132. From that point onwards, the vehicle 100 will decelerate in accordance with the first deceleration profile 122, which may involve using regenerative braking, engine braking (caused by pumping losses of an engine turning on a trailing throttle) or friction braking. The first coasting profile 126 may terminate at an intersection with the first deceleration profile 122 for any of many possible reasons. For example, depending on changes in elevation between the current position of the vehicle and point 120 where the speed limit changes, coasting alone may not allow a sufficient reduction in speed to allow the vehicle to reach 30 km/h by the time it reaches point 120. Alternatively, or in addition, user may find long periods of coasting with slow reductions in speed frustrating. For whatever reason or reasons are chosen, the first coasting profile 126 may be terminate at some point on the first deceleration profile 122.

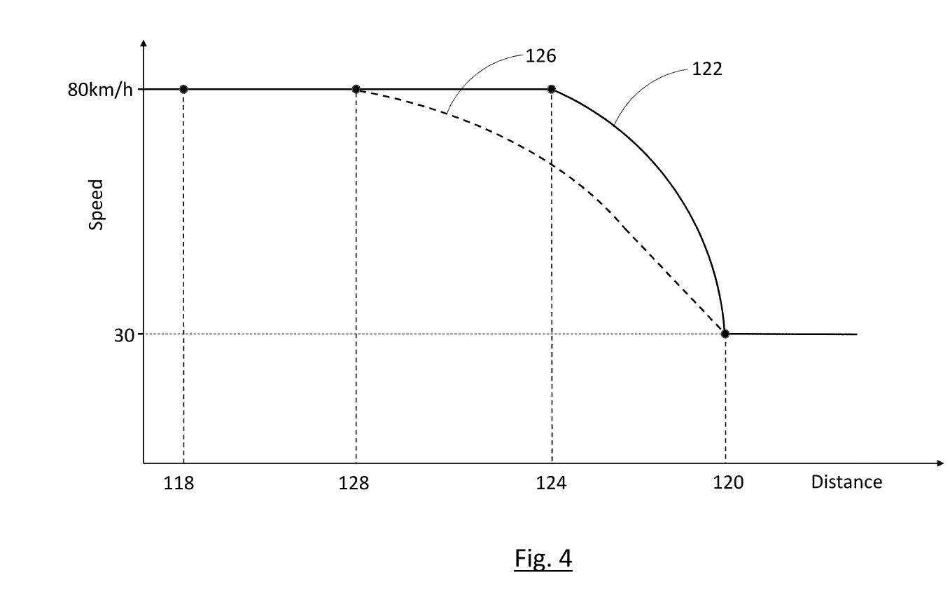

Turning to FIG. 4, there is shown a similar scenario to that shown in FIG. 3. The difference in FIG. 4 is that the first coasting profile 126 does not intersect with the first deceleration profile 122. Instead, the vehicle 100 coasts from its initial speed of 80 km/h all the way to the target speed of 30 km/h at point 120.

Estimating the or each coasting profile may be undertaken in any suitable manner. In an embodiment, such as that of FIG. 3 or 4, only a single coasting profile is estimated. The estimation may involve modelling the way in which the speed of the vehicle changes as it traverses a portion of the path ahead. The process may be iterative. A first approximation may be made based on, for example, a relatively simple model of the change in speed of the vehicle over a portion of the path from a starting point.

An initial starting point (e.g., starting point 128) may be chosen in any suitable manner. For example, the vehicle 100 may locally store or download via a wireless network an indication of a suitable starting point based on data determined by the vehicle or other road users that have previously coasted over a relevant portion of the current vehicle path.

Once an initial starting point is established, the first coasting profile 126 may be estimated by modelling the change in speed of the vehicle as it coasts over the vehicle path after that point. Modelling of the change in speed of the vehicle may be based on the change in elevation over sections of the vehicle path. A majority of this estimated speed reduction may be due to the conversion of kinetic energy to potential energy as the vehicle 100 coasts up a hill, and vice versa. In some embodiments, the coasting profile may be based solely on estimates of speed changes due to this conversion. However, in other embodiments, other factors may also be added to the estimate. For example, the effect of air resistance may be factored in. As those skilled in the art will appreciate, air resistance is higher at higher speeds, and may have a relatively greater impact during relatively flat sections of the vehicle path. Other factors, such as speed loss due to cornering (e.g., due to tyre scrub and/or differential losses), tyre resistance (optionally including the effect of varying tyre pressures), wind, air density (e.g., due to temperature and/or humidity), rain, puddles, road surface type and quality, and known vehicle behaviours at certain speeds or in certain conditions, may also be used in the estimate, whether alone or in combination. These and other factors may be estimated based on direct measurements (e.g., air pressure and temperature), implicit measurements (e.g., vehicle tyre pressure based on measured deceleration at different speeds when coasting) or look-up data (e.g., road surface types may form part of the map information stored or accessed by the electronic map unit 108).

If the coasting profile intersects with the first deceleration profile 122 too soon, then coasting may have started too late. An earlier starting point on the path may then be chosen and the coasting profile estimated again.

If the coasting profile does not intersect with the first deceleration profile 122, then coasting may have started too late. A later starting point on the path may be chosen and the coasting profile estimated again. The process may be iterated until an acceptable intersection with the first deceleration profile 122 is achieved (as in the FIG. 3 embodiment) or the coasting event results in the target speed being achieved at or around the target point (as in the FIG. 4 embodiment).

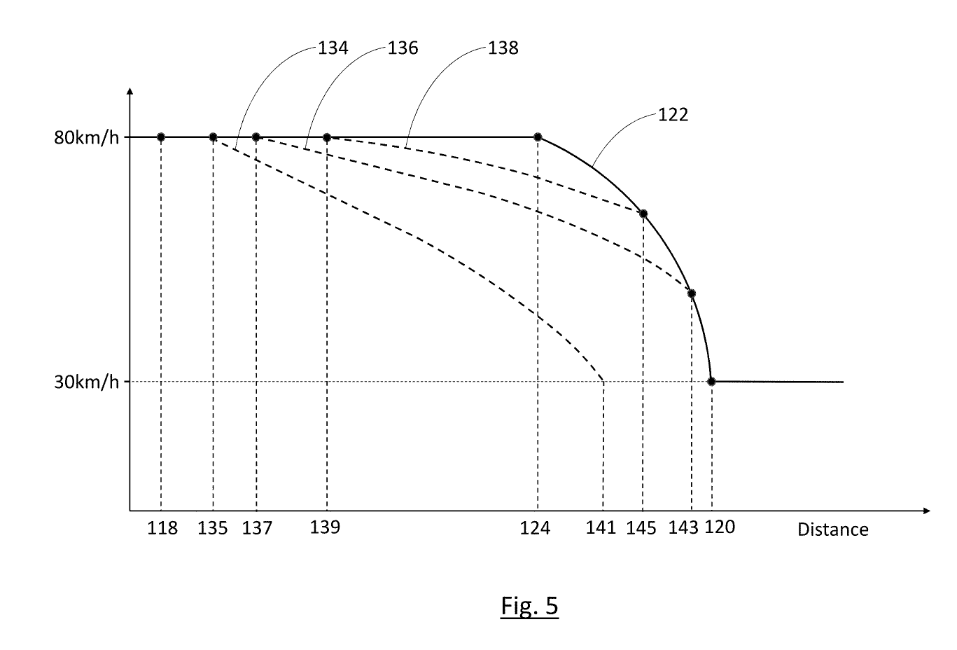

An alternative way of determining which coasting profile to implement is to generate several coasting profiles, each commencing at a different starting point. As shown in FIG. 5, a first coasting profile 134 starting at starting point 135, a second coasting profile 136 starting at starting point 137 and a third coasting profile 138 starting at starting point 139 are generated. The coasting profile closest to the desired coasting behaviour may then be selected for implementation. For example, in FIG. 5, the first coasting profile 134 reaches the target speed too early at point 141 (e.g., it does not intersect with the first deceleration profile 122), and so may be rejected. The second coasting profile 136 intersects with the first deceleration profile 122 at point 143. The third coasting profile 138 intersects with the first deceleration profile 122 at point 145. In an embodiment, the second coasting profile 136 may be selected for implementation in preference to the third coasting profile 138, for example because it involves a longer duration of coasting. In other embodiments, the third coasting profile 138 may be selected, for example because the coasting time of the second coasting profile 136 may be too long for user comfort.

Another way of estimating a coasting profile is to work backwards from one or more end points. The estimation may involve modelling the way in which the speed of the vehicle changes as it traverses a portion of the path ahead, but working backwards rather than forwards. An end point may be chosen in any suitable manner. For example, the vehicle may locally store or download via a wireless network an indication of a suitable end point based on data determined by the vehicle or other road users such as other cars, trucks or busses that have previously coasted over a relevant portion of the vehicle path.

Once an end point is established, a coasting profile may be estimated by modelling the change in speed of the vehicle as it coasts over the vehicle path towards that point. Since the estimates are made working backwards from an end point, it may be necessary to segment the path and model the change in speed over each segment in a forwards direction, but estimating each segment in sequence starting from the one closest to the end point. As with the forward-modelling approach, modelling of the change in speed of the vehicle may be based on the change in elevation over sections of the vehicle path. A majority of this estimated speed reduction may be due to the conversion of kinetic energy to potential energy as the vehicle 100 coasts up a hill, and vice versa. In some embodiments, the coasting profile may be based solely on estimates of speed changes due to this conversion. However, in other embodiments, other factors may also be added to the estimate. For example, the effect of air resistance may be factored in. As those skilled in the art will appreciate, air resistance is higher at higher speeds, and may have a relatively greater impact during relatively flat sections of the vehicle path. Other factors, such as speed loss due to cornering (e.g., due to tyre scrub and/or differential losses), tyre resistance (optionally including the effect of varying tyre pressures), wind, air density (e.g., due to temperature and/or humidity), rain, puddles, road surface type and quality, and known vehicle behaviours at certain speeds or in certain conditions, may also be used in the estimate, whether alone or in combination. These and other factors may be estimated based on direct measurements (e.g., air pressure and temperature), implicit measurements (e.g., vehicle tyre pressure based on measured deceleration at different speeds when coasting) or look-up data (e.g., road surface types may form part of the map information stored or accessed by the electronic map unit 108).

Working backwards, it may be determined whether the coasting profile intersects with the starting speed at a point in front of the current position of the vehicle on the path. If so, then the coasting profile may be selected for implementation.

If the determination results in the coasting profile not intersecting with the starting speed at a point in front of the current position of the vehicle, a different end point may be selected for estimation of a further coasting profile. For example, a later starting point may improve the chance of the coasting profile intersecting with the starting speed at a point in front of the current position of the vehicle. The process may be iterated until an acceptable intersection with the target speed is achieved. Alternatively, or in addition, interpolation between coasting profiles may be used to estimate a further coasting profile.

If it is desired that the coasting profile intersect at a particular point (or within a range) on the first deceleration profile 122, then the end point may be selected accordingly.

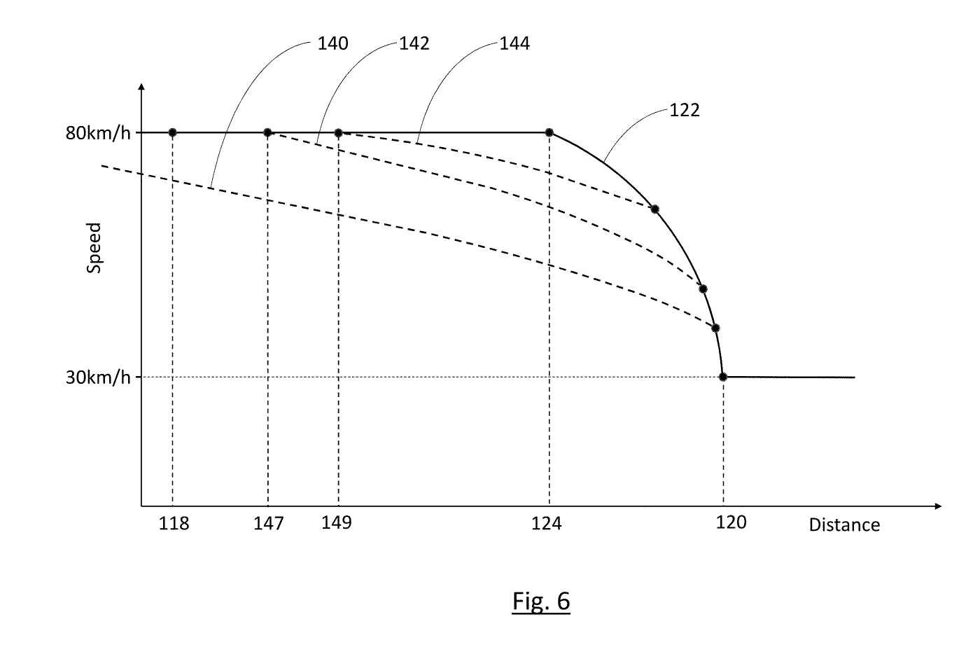

An alternative way of determining which coasting profile to implement is to generate several coasting profiles, each working back from a different end point. As shown in FIG. 6, a fourth coasting profile 140, a fifth coasting profile 142 and a sixth coasting profile 144 are generated. The coasting profile closest to the desired coasting behaviour may then be selected for implementation. For example, in FIG. 6, the fourth coasting profile 140 does not intersect with the starting speed, and so may be rejected. The fifth coasting profile 142 intersects the starting speed at a point 147 in front of the car's current position on the path. The sixth coasting profile 144 intersects the starting speed at a point 149 in front of the car's current position on the path. In an embodiment, the fifth coasting profile 142 may be selected for implementation, for example because it involves a longer period of coasting. In another embodiment, the sixth coasting profile 144 may be selected, for example because the coasting time for the fourth coasting profile 142 may be too long for user comfort.

One or more coasting profiles may be estimated and/or implemented based on a combination of one or more of the “working forward” estimates (e.g., FIGS. 3 and 4), and one or more of the “working backward” estimates (e.g., FIGS. 5 and 6).

Other predetermined coasting requirements may be involved in selecting a particular coasting profile for implementation. For example, it may be desirable, either universally or in certain situations, to only select coasting profiles for which the duration of a coasting event of a coasting profile exceeds a threshold. This may be for reasons of efficiency, for example because it takes a certain amount of energy to restart an internal combustion engine if it is turned off. Alternatively, or in addition, vehicle user comfort may inform the choice of threshold, for example because vehicle occupants may find it uncomfortable if the engine is repeatedly stopped and re-started over short periods of time. A threshold of, for example, 100 metres may be selected as a minimum distance for the coasting mode. In that case, a coasting profile is only implemented if the corresponding coasting event will be effective for more than 100 metres or yards.

The examples above express the coasting event within each coasting profile as a distance. It will be appreciated that the coasting event may also be expressed as a time period instead of, or as well as, a distance. The time period may be determined based on the distance and speed over each coasting profile. A threshold time for the coasting mode associated with each coasting profile may be set as a minimum time (e.g., 10 seconds). In that case, a coasting profile is only implemented if the corresponding coasting mode will be effective for more than 10 seconds.

In yet other embodiments, both a minimum and a maximum period for coasting may simultaneously be required. Such periods may be fixed or user set/selectable.

The first deceleration profile 122 has been described as, for example, a maximum regeneration efficiency profile. However, the one or more coasting profiles may be determined relative to any other non-coasting deceleration profile that is in use by the vehicle 100. For example, the one or more estimated coasting profiles may include at least one period of deceleration that is lower than a trailing throttle deceleration profile (where the vehicle 100 includes an internal combustion engine) or a comfort deceleration profile.

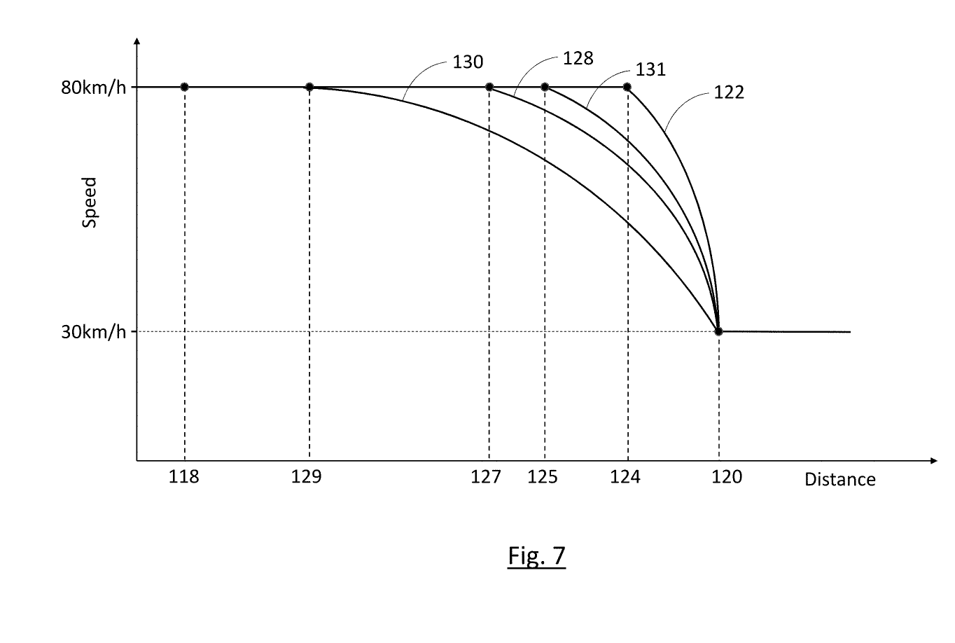

FIG. 7 illustrates three maximum deceleration profiles that may be in use by one or more vehicles such as the vehicle 100.

The first deceleration profile 122 is a maximum regeneration profile, as described above, in which the output of a regenerative motive source (e.g., a kinetic energy recovery system or an electric machine operating in generator mode) is maximised. The first deceleration profile 122 starts at point 124 on the vehicle path.

A second deceleration profile 131 is a maximum regeneration efficiency profile, in which the maximum amount of energy is recovered by a regenerative motive source. While the output of the regenerative motive source is not maximal at any point on the second deceleration profile, the kinetic-to-electric conversion efficiency from start to finish is improved due to the amount of coasting involved. The second deceleration profile 131 starts at point 125 on the vehicle path.

A third deceleration profile 128 is an engine overrun profile representing the amount of deceleration caused by engine braking on zero throttle. The third deceleration profile 128 starts at point 127 on the vehicle path.

A fourth deceleration profile 130 is a comfort profile representing a maximum deceleration that provides acceptable comfort to occupants. The fourth deceleration profile 130 starts at point 129 on the vehicle path.

In the prior art, it may be common to select the second deceleration profile 131 for use in slowing the vehicle from 80 km/h to 30 km/h, because more of the kinetic energy of the vehicle will be recovered than would be the case with the first deceleration profile 122, third deceleration profile 128 or fourth deceleration profile 130. In other cases, the fourth deceleration profile 130 may be selected to take into account user comfort.

The one or more coasting profiles may be determined based on any deceleration profile that would otherwise be used by the vehicle when not coasting. In addition, a composite deceleration profile comprising a combination of portions of such deceleration profiles may also be used. For example, the fourth deceleration profile 130 (comfort) may be used to modify some portion of another deceleration profile, such as the maximum regeneration profile 131.

It will be appreciated that changes between starting speed, coasting event, and (where relevant) the current deceleration profile may either be instantaneous, or may include a transition period where the deceleration changes relatively slowly. This may improve user comfort by avoiding abrupt changes in speed.

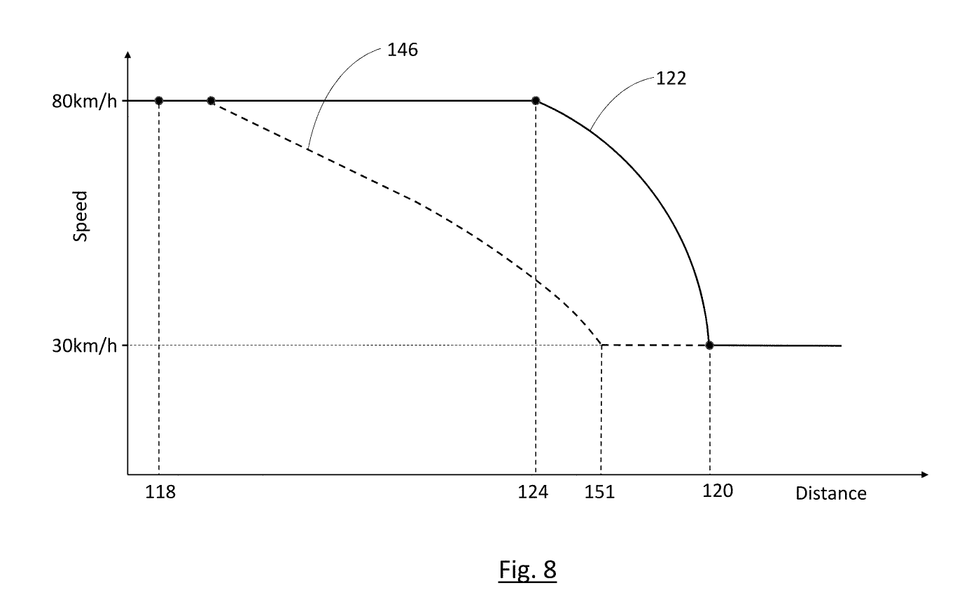

Although embodiments above describe reaching the target speed at or before the target point on the vehicle path, in other embodiments it may be acceptable to allow the target speed to be reached early. Referring to FIG. 8, a coasting profile 146 is estimated, and the result is that the vehicle 100 reaches the target speed at point 151, some time before the target position. Depending upon the available time and processing resources, and external factors such as legal speed requirements and user comfort, it may be considered acceptable to choose this coasting profile and simply allow the target speed to be reached earlier than would otherwise be the case.

Modelling the response of the vehicle to the elevation changes when coasting may account for different levels of coasting. For example, the amount of regenerative braking may be varied, between iterations and/or across each coasting event. For example, if a coasting profile intersects with the first deceleration profile 122 too early (i.e., because the vehicle is moving too fast at that point), it may be desirable to include or increase regenerative or friction braking during at least some of the coasting profile so as to move the intersection point further along the path. Similarly, if it is desirable for the target speed to be met at or close to the target position on the path, and a coasting profile shows the vehicle moving too fast at that point, it may be desirable to include or increase regenerative or friction braking during at least some of the coasting profile so as to cause the vehicle to meet the target speed closer to the target position. Braking may also be desirable to improve user comfort, for example to avoid sudden acceleration and enhancing vehicle composure. Depending upon the implementation, some associated with modelling too many potential compromise may need to be reached, to avoid the processing delays and overheads coasting profiles. The skilled person will appreciate that regenerative braking of this sort may only be possible in some hybrid vehicle architectures in which the electric motor or motors are in the drivetrain downstream of the transmission.

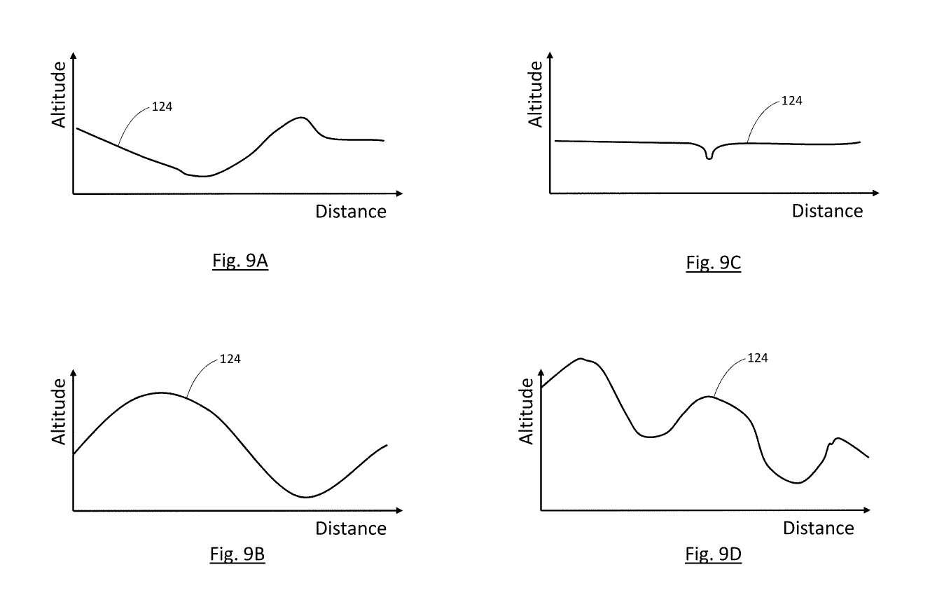

The examples above show a relatively simple scenario of a flat path between the vehicle and the target point. Coasting may also be modelled when the elevation change between the vehicle and the target point is more complex. For example, FIGS. 9A to 9D show non-exhaustive examples of terrain maps for a predicted path of the car.

FIG. 9A shows a terrain map 124 with a downhill section, followed by a shorter uphill section, an even shorter downhill section, followed by a flat section.

FIG. 9B shows a terrain map 124 with a short uphill section follow by longer downhill and uphill sections.

FIG. 9C shows a terrain map 124 with a flat section followed by a short downhill and uphill section, followed by a longer flat section.

FIG. 9D shows a terrain map 124 with a series of uphill and downhill sections, in which each subsequent peak is lower than the last.

The terrain map 124 may comprise any other combination of uphill, downhill and flat sections. It should expressly be noted that all illustrated coasting profiles are schematic in nature and are not intended to accurately illustrate real-world acceleration and deceleration due to the terrain map.

Where multiple coasting profiles are estimated, there may be an advantage to increasing the number of such profiles where the terrain map 124 includes steep and/or complex elevation profiles. Alternatively, or in addition, starting points (or end points, where the “working back” approach is used) may be packed more closely together where the terrain map 124 includes steep and/or complex elevation profiles in the vicinity thereof.

The prime mover of the vehicle may be any one or more drive sources. In a conventional vehicle, the prime mover may be one or more internal combustion engines such as a two-stroke or four-stroke diesel or petrol engine, or a turbine. In that case, entering a coasting mode may comprise one or more of:

placing a transmission associated with the internal combustion engine into neutral;

disengaging a clutch associated with the internal combustion engine;

engine braking;

turning off the internal combustion engine; and

modulating one or more engine system actuators, such as an exhaust gas recirculation valve, variable geometry turbocharger, intake throttle, and continuous variable valve timing, so as to reduce or minimise pumping losses. The engine system actuators may be engine air system actuators.

An advantage of placing the transmission into neutral and/or disengaging the clutch is that the internal combustion engine is no longer turned via its connection to drive wheels of the vehicle. Even when an internal combustion engine is turned off, deprived of fuel and/or used for engine braking, there may be significant frictional and pumping losses, as a result of the rotation of the crank and reciprocation of pistons, for example.

An advantage of modulating one or more engine system actuators as described above is that pumping losses (or air pumping losses) may be reduced sufficiently that the engine may not need to be turned off or the clutch disengaged in order to obtain some improvements in fuel efficiency while coasting.

Alternatively, or in addition, the prime mover may include one or more electrical motors, such as a DC or AC motor. In that case, entering a coasting mode may comprise one or more of:

providing no drive via the one or more electrical motors;

providing regenerative braking via the one or more electrical motors; and

providing reduced drive via the one or more electrical motors.

It will be understood that where coasting involves regenerative braking or reduced drive (electrical motors), and/or turning off the engine or engine braking (internal combustion engine), these mechanisms may be deployed in such a way that the deceleration they cause is less than that which would result from the use of those mechanisms when not coasting. For example, regenerative braking is generally employed in a way that maximises the amount of energy that may be recovered, within the context of a maximum braking profile for vehicle user comfort. In the present case, the amount of regenerative braking (and/or the reduced drive) may be selected such that the amount of regenerated energy during any regenerative phase is less than the maximum possible had coasting not been employed. When considered over the entire coasting event, however, the net energy position is improved—i.e., coasting results in less energy being used in total, compared with allowing maximum regenerative braking without coasting.

Other states that may be involved when coasting include:

Engine over-run (also known as engine braking, deceleration fuel shut off, engine connected coasting) is a state in which the internal combustion (IC) engine remains connected to a driveline of the vehicle via a transmission. The vehicle is allowed to roll, without application of the accelerator pedal. In this condition fuel may be cut-off (so called deceleration fuel shut-off) and the vehicle slowly decelerates due to engine braking (‘engine over-run’) and other external factors. Such coasting may be referred to as ‘engine-connected coasting’ and includes the (zero throttle) condition in which the vehicle can maintain speed without assistance from the IC engine or electric machine, such as rolling downhill, as well as the (zero throttle) level-driving condition in which speed is deliberately permitted to fall without braking of the vehicle wheels by means of the braking system. During engine-connected coasting, IC engine speed is a function of the speed of the vehicle and the gear ratio of the transmission, so is typically higher than idle speed. In an IC engine, relatively high friction and pumping losses cannot be avoided, notwithstanding that fuel is cut-off. Eventually, engine-connected coasting may cause the engine speed to fall to a level at which fuel must be readmitted (the fuel cut-in speed) to avoid stalling of the engine upon fuelling. The fuel cut-in speed is generally close to normal engine idle speed.

Engine stop sail (also known as sailing, freewheeling, high speed free rolling) is a state in which the drivetrain is opened (the internal combustion engine and the transmission are decoupled) and the IC engine is cut. No fuel is used and losses are minimised. As long as there is an efficient method to restart the engine, this is usually the most efficient of coasting states.

Neutral coasting (also known as idle coasting, engine-on sail) is a state in which the vehicle transmission is shifted into neutral, so that engine speed can drop to idle. In an IC engine, fuel must be admitted to the engine to keep it running at idle speed, so that from a fuel economy viewpoint, the advantage of deceleration fuel shut-off is lost, but lower friction windage and pumping losses may apply.

Simulated coasting (hybrid only) is a state in which the engine and/or a belt-integrated starter generator (“BISG”), or crankshaft-integrated motor generator (CiMG), are caused to deliver positive torque to the transmission in an amount sufficient to overcome internal losses associated with the engine, transmission and driveline. The transmission remains connected to the driveline. The amount of positive torque delivered in order to overcome internal losses may be determined in dependence on vehicle speed according to a look-up table. A sub-category of simulated coasting is when an engine produces positive power to charge the high voltage battery through a generator motor.

High-speed stop on the move is a state in which the engine is stopped and speed remains relatively constant due to local conditions. Using knowledge of local gradient (e.g. using e-horizon data) the vehicle maintains a current speed.

Low-speed stop on the move is a state employed during short stops, in which the vehicle cuts the fuel supply to the engine in order to save fuel and then re-starts when it needs to move off. This is known as ‘stop-start’ and is may be used on both automatic and manual transmission vehicles. Low-speed stop on the move extends the engine cut event to the time before the vehicle comes to a complete stop. This stop event relies on certain pre-set conditions such as vehicle speed and brake actuation i.e. the vehicle must be below a certain speed and the driver must have the brake pressed for the engine to cut.

One way of characterising “coasting” as used herein is the use of a vehicle's momentum. In at least some embodiments, “coasting” may in particular involve reducing fuel or energy use.

Optionally in any embodiment, a range of allowable speeds may be wider during a coasting mode of the vehicle 100 than when the vehicle is not coasting. The range may be a considered an envelope of speeds within which the coasting profile must fit.

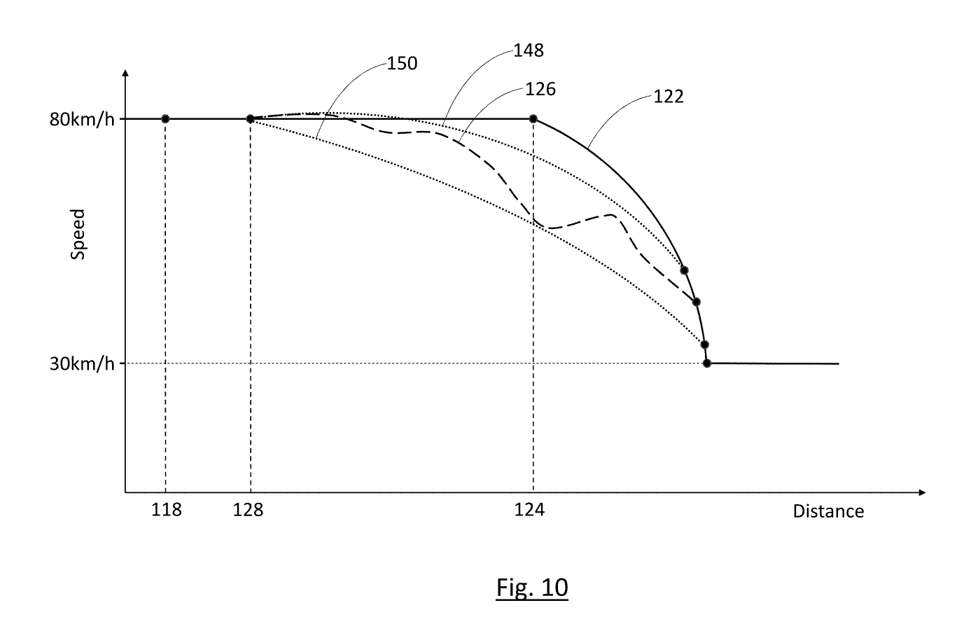

Turning to FIG. 10, there is shown a graph of speed versus distance for a vehicle employing an embodiment of the present invention. The starting speed (80 km/h) before point 128 represents a cruise control set speed. This is the nominal speed that the cruise control or driver assistance feature is set to maintain. This may be a specific speed (e.g., 80 km/h), or a relatively narrow range of speeds (e.g., 80 km/h+1/−2 km/h). This speed, or range of speeds, is maintained when the vehicle is not coasting.

A coasting speed envelope includes an upper line 148 that represents an upper speed limit that the vehicle 100 may not exceed during a coasting mode. This upper limit may be determined with reference to several factors, including one or more posted or legal speed limits that apply at various points along the path, speed limits imposed by a need to meet emissions or fuel consumption rules under which the vehicle is operating, or user preference indicated by way of user input (e.g., a user may not feel comfortable travelling above a particular speed, and vehicle composure may be compromised, if corners are taken too fast).

The coasting speed envelope includes a lower line 150 that represents a speed limit below which the vehicle 100 may not fall during the coasting mode. This lower limit may be determined with reference to several factors, including one or more posted or legal minimum speeds that apply at various points along the path, speed limits imposed by a need to meet emissions or fuel consumption rules under which the vehicle is operating (e.g., a particular vehicle may be less efficient below certain speeds due to gearing), and/or user preference indicated by way of user input (e.g., a user may feel frustrated if the vehicle slows down too much, or may be in a hurry on a particular journey). It will be noted that the first coasting profile 126 in FIG. 10 includes a more complex pattern of speed increases and decreases, due to changes in elevation including uphill and downhill sections.

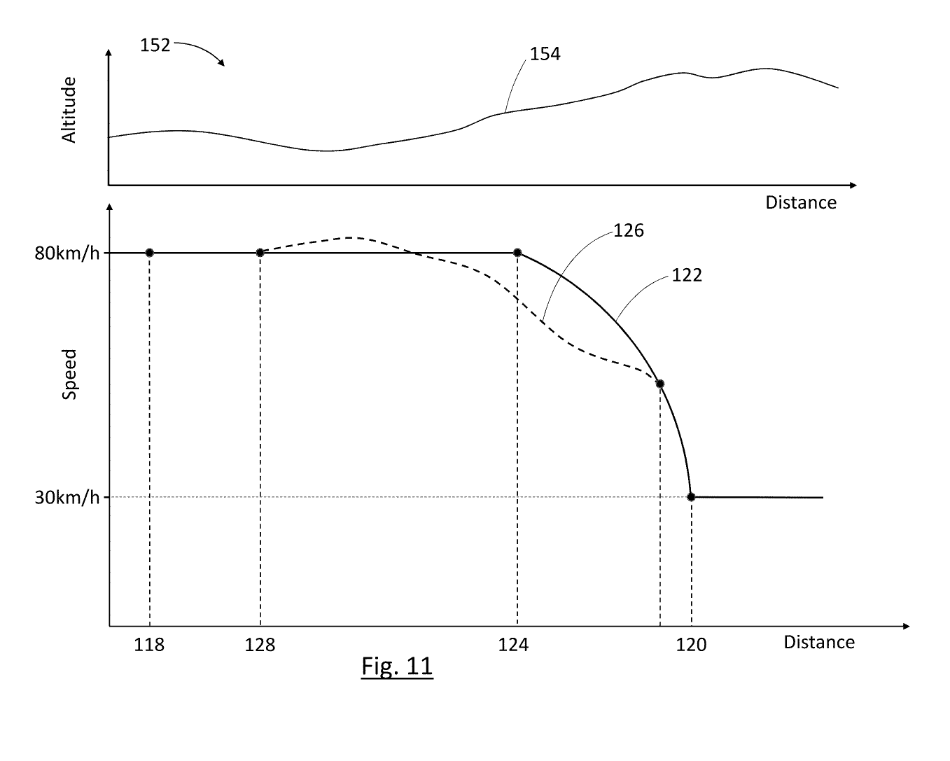

Turning to FIG. 11, there is shown a graph of speed versus distance with a terrain map 152 above it. The terrain map 152 shows how the elevation 154 of the path changes along the length of the path. A first coasting profile 126 is generated as described above, starting at point 128. The speed of the vehicle is modelled, taking into account the elevation 154 at each corresponding point along the path, until it intersects with the first deceleration profile 122 at point 132. It will be noted that the speed control system maintains the vehicle speed at 80 km/h up until point 128, despite the fact that the elevation 154 includes an uphill section followed by a downhill section over the same portion of the path. The first coasting profile, however, shows an increase in speed as the vehicle is placed into a coasting mode at point 128, due to the fact that the vehicle is headed downhill at this point. From point 156 on the terrain map 152, there is a long uphill section. The vehicle responds by slowing down. The vehicle slows down at a greater rate on steeper portions of the hill. Once the vehicle reaches the point 132 of intersection with the first deceleration profile, the speed control system acts to tightly control the car's speed again. The speed of the vehicle follows that indicated by the first deceleration profile, despite any changes in uphill angle. It then maintains the target speed of 30 km/h from point 120, again despite changes in elevation.

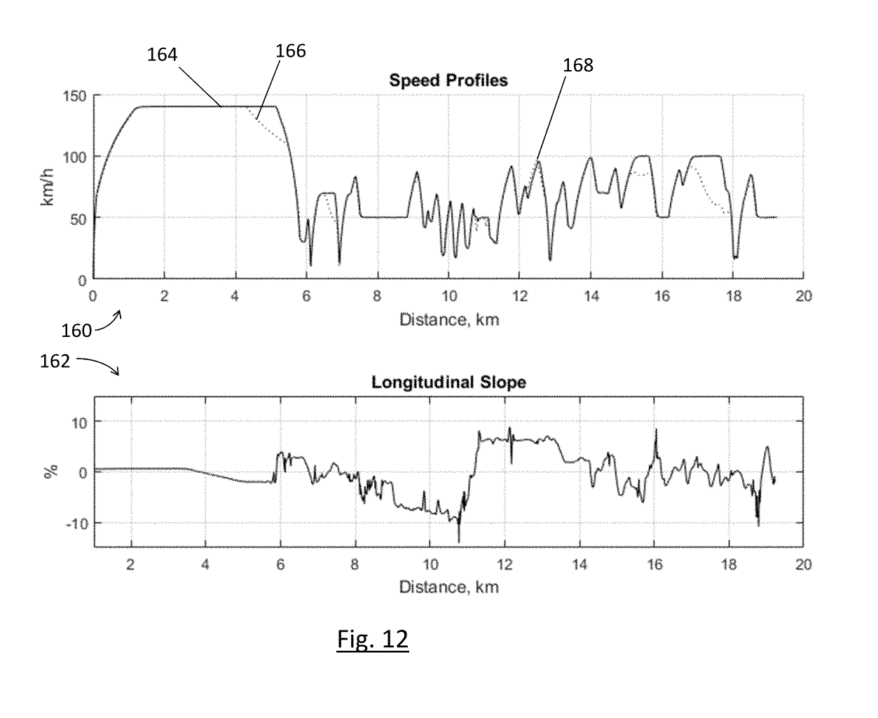

Turning to FIG. 12, there is a graph 160 of speed versus distance for a vehicle, along with a graph 162 of longitudinal slope over the same distance. In graph 160, the sold line 164 shows the instantaneous speed of the vehicle across the full distance. The changes in speed represent the speed response of the vehicle to the terrain (i.e., elevation changes/slope), legal speed limit, corners, and other situations where the speed needs to be adjusted. The speed may be controlled by the driver, or cruise control or driver assistance may be used. The dotted line 166 shows periods where the vehicle would be put into a coasting mode as described above (i.e., automatically by the vehicle, or manually under control of the user, for example).

Most of the time when not in coasting mode, the car's speed is at or close to the maximum for the situation. Accordingly, most periods of coasting involve slower speeds than when the vehicle is not coasting at the same point. In one situation in FIG. 12, indicated by reference sign 168, the speed when coasting is higher than it would have been if the vehicle had not been coasting. This may be because, for example, the upper allowable speed for the vehicle at this point is higher in the coasting mode than in the non-coasting mode, and the specific combination of elevation change, legal speed limit, and other factors resulted in a coasting speed that is faster than the non-coasting speed would have been at that point.

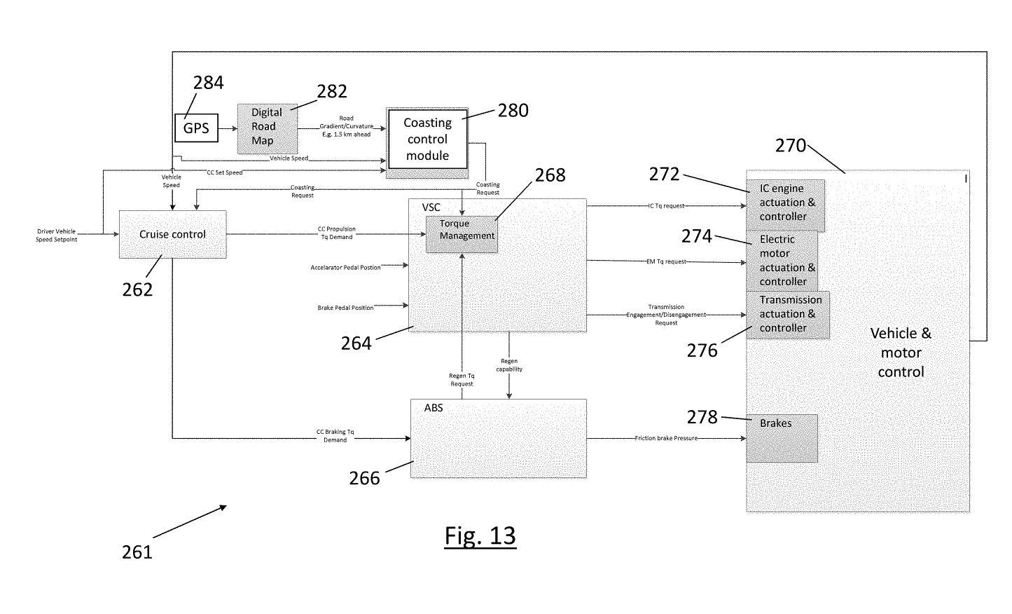

Turning to FIG. 13, there is shown an example of a vehicle coasting system 261 for assisting in the control of a prime mover of a vehicle. The vehicle coasting system 261 may take the form of a general purpose processor programmed and configured to implement any of the methods described above. The apparatus may perform related functions, such as cruise control and/or torque management, or may be entirely separate from the processor(s) that implement such functions. Each of the modules described below may take the form of an individual piece of hardware, or may comprise software that runs on one or more processors.

The vehicle coasting system 261 comprises cruise control module 262 that accepts as inputs a speed setpoint from the user, the current vehicle speed and a coasting request. The speed setpoint may be input by the user in any suitable manner known to those skilled in the art, such by manually indicating by way of an input such as a stalk or button when a desired speed is reached, or by inputting a specific desired speed via, for example, a keypad. The cruise control module 262 also accepts as an input the current vehicle speed and a coasting request, the sources of which are described below.

The cruise control module 262 outputs a cruise control propulsion demand to a vehicle supervisory controller (VSC) module 264 and a cruise control braking demand to the ABS braking module 266.

The cruise control propulsion demand is routed to a torque management module 268 within the VSC module 264. The torque management module 268 also accepts as inputs the same coasting request as was received by the cruise control module 262 and a regenerative braking request from the ABS braking module 266.

The VSC module 264 also accepts as inputs an accelerator pedal position and a brake pedal position.

The VSC module 264 outputs an internal combustion (IC) request, an electric motor (EM) request and a transmission engagement/disengagement request. These three requests are supplied to a vehicle and motor control module 270. The IC request is routed to an IC engine actuation and controller module 272, the EM request is routed to an electric motor actuation and controller module 274, and the transmission engagement/disengagement request is routed to a transmission and actuation controller 276.

The ABS braking module 266 accepts as an input a regeneration capability signal from the VSC 264. The ABS braking module 266 also outputs a friction brake pressure signal that is supplied to the vehicle and motor control module 270 and routed to brakes 278 of the car.

The vehicle and motor control module 270 outputs the current vehicle speed that was earlier described as being supplied to the cruise control module 262. The current vehicle speed is also supplied to means for generating a coasting profile in the form of a coasting control module 280. The coasting control module 280 also receives as inputs road gradient and curvature from a digital road map 282 and the cruise control set speed. The coasting control module 280 outputs a coasting request to the cruise control module 262 and the torque management module 268.

The digital road map 282 receives current vehicle position information from a GPS unit 284.

In this particular embodiment, all of the modules except the digital road map module 282 and the coasting control module 280 are conventional other than in relation to signalling inputs and outputs required by the addition of the coasting control module 280 and digital road map 282.

In use, the cruise control module 262 operates to maintain the speed of the vehicle within +1 km/h and −2 km/h of a set speed input by the user when not coasting. In parallel, the coasting control module 280 uses the current speed, the set speed and the digital road map to generate a plurality of coasting profiles, as described above. When a suitable coasting profile is identified and selected for implementation by the coasting control module 280, it outputs a coasting signal that effectively instructs the cruise control module 262 and the torque management module 268 to enter the coasting mode.

In the embodiment illustrated, the coasting signal is sent at the point on the current path of the vehicle corresponding with the starting point of the selected coasting profile. Alternatively, the coasting signal may be sent earlier to account for delays involved in entering the coasting mode. For example, it may take a small number of seconds to shut down the IC motor, in which case the coasting signal to enter the coasting mode may be sent that number of seconds before the vehicle is expected to arrive at the point on the current path of the vehicle corresponding with the starting point of the selected coasting profile.

Upon receipt of the coasting signal, the cruise control module 262 adopts a wider speed range, such as +2 km/h and −4 km/h, thereby allowing greater increases and decreases in speed before it intervenes. The torque management module 268 may instruct the transmission controller module 276 to place the transmission of the vehicle into neutral, and/or disengage a clutch to disconnect drive from the IC engine. Alternatively or in addition, the IC engine may be turned off via the IC engine actuation and controller module 272. Any or all of the modules within the vehicle and road module may be controlled to cause the vehicle to coast, in accordance with the definition of coasting given above.

Once the coasting control module 280 determines that the vehicle has reached the end of the selected coasting profile, the coasting request is cancelled. The cruise control adopts the narrower, non-coasting speed range. The torque management module 268 and/or ABS braking module 266 control their respective modules within the vehicle and motor control module 270 as required. This may involve restarting the IC engine, selecting a transmission gear, reengaging the clutch, and/or controlling the IC engine, electric motor, transmission and brakes in accordance with the requirements of the non-coasting mode.

As was the case when sending the coasting signal, an instruction to exit the coasting mode may be issued at the point on the current path of the vehicle corresponding with the end point of the selected coasting profile. Alternatively, the instruction to exit may be sent earlier to account for delays involved in exiting the coasting mode. For example, it may take a small number of seconds to start up the IC motor, in which case the instruction to exit the coasting mode may be sent that number of seconds before the vehicle is expected to arrive at the point on the current path of the vehicle corresponding with the end point of the selected coasting profile. Sending the instruction early also ensure that the vehicle has time to take any other steps necessary to ensure consistent driveability and safety.

The coasting mode may also be terminated if the predicted path changes (e.g., the vehicle unexpectedly changes route), the current speed deviates too far from that indicated by the coasting profile, or if the current speed exceeds or falls below the coasting mode speed range.

The previous embodiments have described controlling a prime mover of the vehicle to place the vehicle into a coasting mode in accordance with the at least one identified coasting profile. In other embodiments, instead of placing the vehicle into a coasting mode, feedback may be provided to a vehicle user (such as a driver) to place the vehicle into the coasting mode. Such feedback may make any suitable form, such as:

Audible: a sound or synthesised voice is used to provide the feedback;

Visual: one or more of text, images and/or icons may be displayed to the user by way of an instrument cluster, a heads-up display, a screen, one or more lights, or any other visual indicator; and

Tactile: vibration or other tactile feedback may be provided via one or more actuators in, for example, the steering wheel, seat or foot pedals.

These feedback options are provided as examples only. The skilled person will appreciate that any other form of feedback may be used to tell the user to place the vehicle into a coasting mode.

The driver or other user may, in response to the feedback, take steps to put the vehicle into the coasting mode. For example, in a vehicle with a manual transmission, the driver may depress the clutch, and/or place the vehicle transmission into neutral. Alternatively, an input such as a touch-screen or dedicated button may be used by the user to indicate to the vehicle should enter the coasting mode.

The feedback may be provided immediately before the user should indicate whether to enter the coasting mode. Alternatively, the user may be given more notice. In some cases, this may enable to the user to indicate well in advance that the coasting mode should be entered (e.g., where the vehicle is taking responsibility for placing itself in the coasting mode). In other cases, it gives the user ample time to get ready to place the vehicle into the coasting mode. The feedback may be split into a preliminary indication, to prepare the user, and a secondary indication to let the user know that the vehicle should be placed into the coasting mode.

In all cases, the vehicle may optionally be placed into one of two or more modes, such as, for example:

coasting is entered automatically;

confirmation from the user is awaited for each coasting event; or

the vehicle should not enter (or provide feedback about) entering the coasting mode.

In other embodiments, a user other than the user may receive and/or act upon the coasting mode feedback. This may have particular application in, for example, autonomous or semi-autonomous vehicles.

Although the invention has been described reference to a number of specific non-exhaustive and non-limiting embodiments, the skilled person will appreciate that the invention may be embodied in many other forms.

1. A method of assisting in the control of a prime mover of a vehicle, the method comprising:
determining a target speed that must be reached by the vehicle at a target position on a current path of the vehicle;
estimating one or more coasting profiles for at least part of the vehicle path before the target position at least partly based on a geometry of the at least part of the vehicle path;
determining at least one of the one or more coasting profiles that meets at least one predetermined coasting requirement; and
outputting a coasting signal to either:
control the prime mover to place the vehicle into a coasting mode based on the determined at least one coasting profile; or
provide feedback to a vehicle user to place the vehicle into a coasting mode, such that the vehicle if placed in the coasting mode by the user will coast in accordance with the determined at least one identified coasting profile; wherein:
the vehicle has a predetermined maximum deceleration rate, and wherein the estimated one or more coasting profiles includes at least one period of deceleration having a deceleration rate that is lower than the maximum deceleration rate.

2. The method of claim 1, wherein the at least one predetermined coasting requirement comprises one or more of:
a minimum coasting mode duration;
a minimum coasting mode distance;
a minimum coasting mode speed; and
a maximum coasting mode speed.

3. The method of claim 1, wherein the control of the prime mover comprises one or more of:
placing a transmission associated with the prime mover into neutral;
disengaging a clutch associated with the prime mover;
turning off the prime mover; and
modulating one or more engine system actuators, including an exhaust gas recirculation valve, variable geometry turbocharger, intake throttle, and continuous variable valve timing, so as to reduce or minimise pumping losses.

4. The method of claim 1, wherein the vehicle includes a regenerative power source, and the coasting mode includes regenerative braking.

5. The method of claim 1, wherein the vehicle includes an electric machine, and wherein the coasting mode includes providing drive via the electric machine in order to increase a total coasting distance and/or a total coasting time.

6. The method of claim 1, wherein the vehicle includes one or more braking mechanisms, and wherein the coasting mode includes providing braking via at least one of the braking mechanisms in order to increase a total coasting distance and/or a total coasting time.

7. The method of claim 1, wherein the vehicle has at least a first speed range that is used in estimating the one or more coasting profiles, and a second speed range for when the vehicle is not in the coasting mode, wherein the first speed range is wider than the second speed range.

8. A non-transitory computer readable medium containing computer readable code which when executed causes a vehicle to carry out the method of claim 1.

9. A vehicle coasting system for assisting in the control of a prime mover of a vehicle, the vehicle coasting system comprising:
means for determining a target speed that must be reached by the vehicle at a target position on a current path of the vehicle;
means for estimating one or more coasting profiles for at least part of the vehicle path before the target position at least partly based on a geometry of the at least part of the vehicle path;
means for determining at least one of the one or more coasting profiles that meets at least one predetermined coasting requirement; and
means for outputting a coasting signal for either:
controlling the prime mover to place the vehicle into a coasting mode based on the determined at least one coasting profile; or
providing feedback to a vehicle user to place the vehicle into a coasting mode, such that the vehicle if placed in the coasting mode by the user will coast in accordance with the determined at least one coasting profile; wherein
the vehicle has a predetermined maximum deceleration rate, wherein each of the one or more estimated coasting profiles includes at least one period of deceleration that includes a deceleration rate that is lower than the maximum deceleration rate.

10. The vehicle coasting system of claim 9 wherein the means for estimating the one or more coasting profiles, comprises:
an electronic processor having an electrical input for receiving signals indicative of a value of vehicle speed, a current location of the vehicle, map information, and geometry data relating to the map information; and
an electronic memory device electrically coupled to the electronic processor and having instructions stored therein, wherein
the electronic processor is configured to access the electronic memory device and execute the instructions stored therein such that the electronic processor is operable to predict the vehicle path based at least in part on the signals indicative of the current location of the vehicle and the vehicle speed, and, in dependence on the predicted vehicle path and the geometry of the path, estimate the coasting profile.

11. The vehicle coasting system of claim 9, wherein the at least one or more predetermined coasting requirement comprises one or more of:
a minimum coasting mode duration;
a minimum coasting mode distance;
a minimum coasting mode speed; and
a maximum coasting mode speed.

12. The vehicle coasting system of claim 9, wherein the control of the prime mover comprises one or more of:
placing a transmission associated with the prime mover into neutral;
disengaging a clutch associated with the prime mover;
turning off the prime mover; and
modulating one or more engine system actuators, including an exhaust gas recirculation valve, variable geometry turbocharger, intake throttle, and continuous variable valve timing, so as to reduce or minimise pumping losses.

13. The vehicle coasting system of claim 9, wherein the vehicle includes a regenerative power source, and the coasting mode includes regenerative braking.

14. The vehicle coasting system of claim 9, wherein the vehicle includes an electric machine, and wherein the coasting mode includes providing drive via the electric machine in order to increase a total coasting distance and/or a total coasting time.

15. The vehicle coasting system of claim 9, wherein the vehicle includes one or more braking mechanisms, and wherein the coasting mode includes providing braking via at least one of the braking mechanisms in order to increase a total coasting distance and/or a total coasting time.

16. The vehicle coasting system of claim 9, wherein the vehicle has at least a first speed range that is used in the estimating of the one or more coasting profiles, and a second speed range for when the vehicle is not in the coasting mode, wherein the first speed range is wider than the second speed range.

17. A vehicle comprising the vehicle coasting system of claim 9.
